(19) United States
(12) Patent Application Publication
(10) Pub. No.: US 2004/0098378 A1
(43) Pub. Date: May 20, 2004

(54) Distributed client server index update system and method

(76) Inventors: Gur Kimchi, New York, NY (US); Meyrav Kimchi, New York, NY (US)

Correspondence Address: Gur Kimchi, 44 EAST 12 STREET, APT 5C, NEW YORK, NY, 10003, US

(21) Appl. No.: 10/299,152

(22) Filed: Nov. 19, 2002

(51) Int. Cl. G06F 7/00

(52) U.S. Cl. 707/3

(57) ABSTRACT

A system and method is described for the effective implementation of providing an up-to-date document index using distributed client-server execution. Said system comprising of a code generator on the server-side of the system, a code execution method on the client-side of the system, and a code execution method on the client-side of the system. The system and method described insure that the more searches are performed on a given document, the more up-to-date its index entry shall be, as new documents are introduced, they are available for searching in a more timely manner.

### FIELD OF INVENTION

The present invention relates generally to the field of data indexing and searching. More specifically, the present invention is related to maintaining an up-to-date index of dynamic information.

### BACKGROUND OF THE INVENTION

In classic search systems a “spider” process traverses an information tree, feeding information to an indexing service, which updates the “master index”. Upon a search request, the master index or a replica of the master index is consulted and the result is formatted in some presentation-sensible order, depending on the search model and algorithm. Additionally, the index itself may be formatted using a unique scheme that is optimized for the target search-result presentation.

In the Internet, search engines (such as www.AltaVista.com, www.Google.com and others) traverse the Internet looking for information, feeding the index with any new or updated page found. The main limit of such a system is that due to the large size of the Internet, the time it takes for a search engine's spider to complete such a index-updating round can measure in months. When searching highly dynamic information, existing search engines many times return out-of-date index entries, and when searching for newly published information, the long time it takes the spider to locate the new page, by traversing the Information tree link-by-link makes the information unavailable for searching for weeks or months at the time.

The solutions for these problems which are known in the art are customized indexes and manual updating. In customized indexes a custom search interface is created to access the specific custom index, which is specifically optimized to search a much smaller, and therefore more temporally controlled, information database, leading to better search results.

In the manual method, information publishers wishing to update the index when a publication (such as a web page) is updated send the universal resource locator (URL) or other information informing the spider that this specific information has been added or updated. As the submitter of the information has no ability to influence individually the sequence by which the spider will index this new information, both of these solutions are known as not supporting up-to-date indexing of highly dynamic information.

### SUMMARY OF THE INVENTION

In a client-initiated indexing system, index entries for published information that is searched frequently are more up to date. When users perform a search, a special code generator in the search application generates code to compare the index presentation of the published information to the actual presentation at the published information actual location.

This code can be generated in the form of Java Applet, JavaScript code, ActiveX code or other types of code suitable for client-side execution. Said code is then transmitted with the search result to the requesting user, and when received at target user client station, compares the found document index entry information with the actual original document information.

If said index entry is out of date and does not represent the actual document, the code then communicates with a new priority queue at the search engine to inform the system that the document has been modified.

The more clients update the priority queue that a document is out of date, the priority of the re-indexing request increases, insuring that documents that are search frequently are always as up to date as possible, as their index entries will be refreshed more often.

As search replies may contain more the one possible match, the code generator generates code that will compare multiple documents in the search results with their index representation. Because said execution occurs at the client and not at the server, the performance of the search system is not compromised in any way, while at the same time the quality and the timeliness of the index is increased.

Additionally, said client-executing code can further search each link found in a search result document and compare it to its index representation recursively, making full use of the distributed index refresh system this invention introduces.

### BRIEF DESCRIPTION OF THE DRAWINGS

FIG. 1 illustrates an existing system known in the art for information indexing.

FIG. 2 illustrates the additional capabilities of the present invention

FIG. 3 illustrates the additional capabilities of the present invention for client-executed recursive spider capabilities.

### DESCRIPTION OF THE PREFERRED EMBODIMENTS

While this invention is illustrated and described in a preferred embodiment, the system may be produced in many different configurations, forms and materials. There is depicted in the drawings, and will herein be described in detail, a preferred embodiment of the invention, with the understanding that the present disclosure is to be considered as a exemplification of the principles of the invention and the associated functional specifications of the materials for its construction and is not intended to limit the invention to the embodiment illustrated. Those skilled in the art will envision many other possible variations within the scope of the present invention.

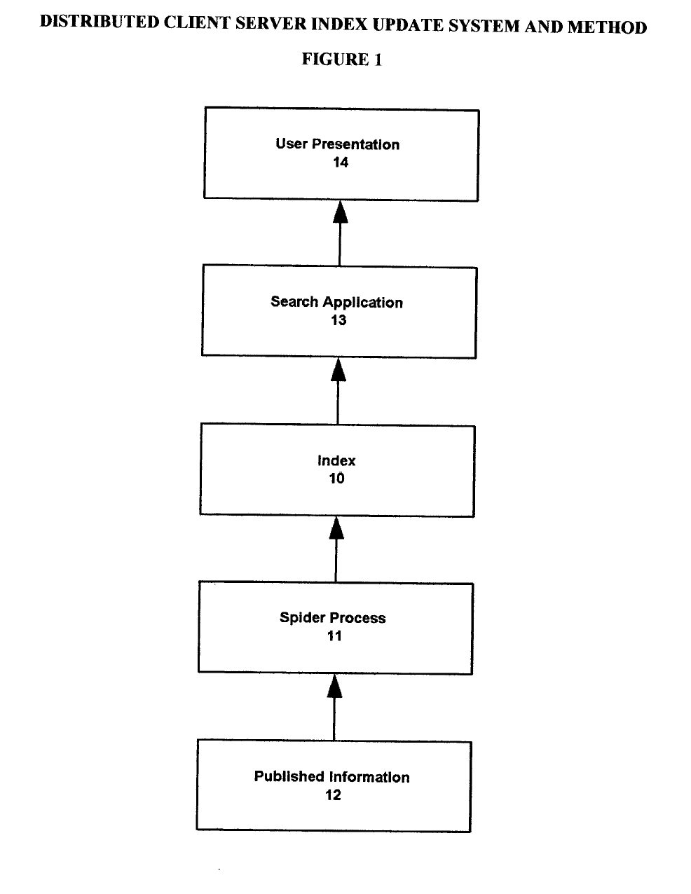

FIG. 1 illustrates the components of an existing system known in the art that performs indexing. Information 12 is retrieved by a spider process 11 using some known or new method, such as a local area network, the Internet, a wireless network, using a protocol such as HTTP, FTP, WAP or other mediums, and fed to index 10. Search application 13 reacts to user requests and searches the index 10 for search terms, showing search results 14 in some user accessible format, such as a HTML page, text document, or other form. Such a system is presented in U.S. Pat. No. 5,892,908, and the present invention introduces a revolutionary enhancement to such a system.

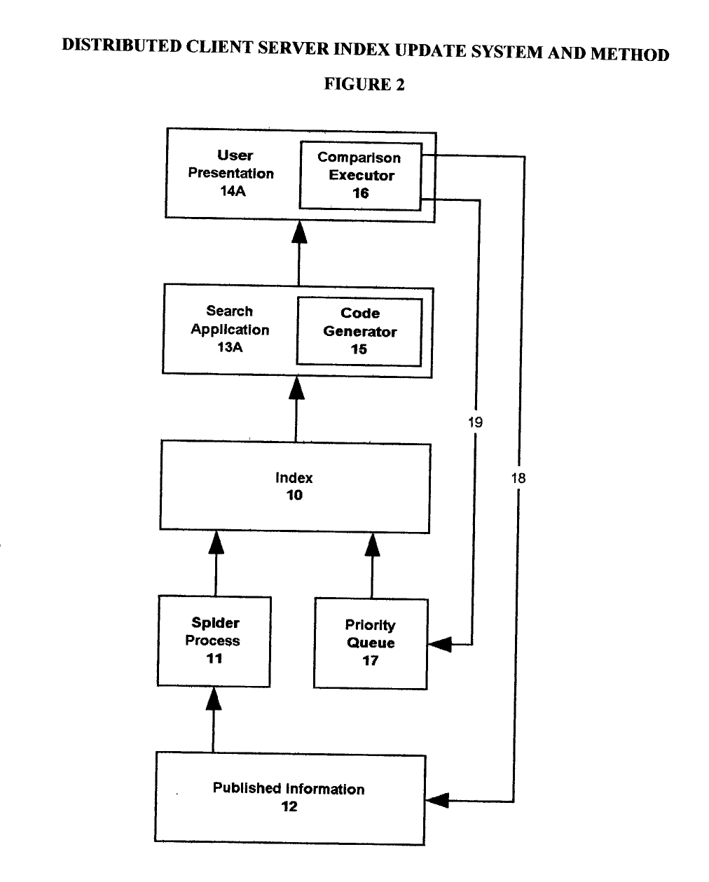

FIG. 2 illustrates the components of a preferred embodiment of the present invention and their interconnections. In addition to procedures described above, a Code Generator 15 next to or integrated with modified search application 13A generates code that will execute on the client side to compare document 12 with its index representation in 10. When transmitted to the requesting user for modified user presentation at 14A, said code 16 will compare 18 one or more search results with index representation at 10, comparing 18 with the original documents 12.

When said code 16 finds document(s) whose index representation is out of date, it will send 19 a pointer to that document to priority queue 17. Priority Queue 17 is designed to increase the priority of documents pointers the more clients 16 inform it of a document's index entry invalidity, insuring it will be updated in the index 10 earlier, hence the more searches find a specific document 12, the more up-to-date that document's index entry at 10 shall be.

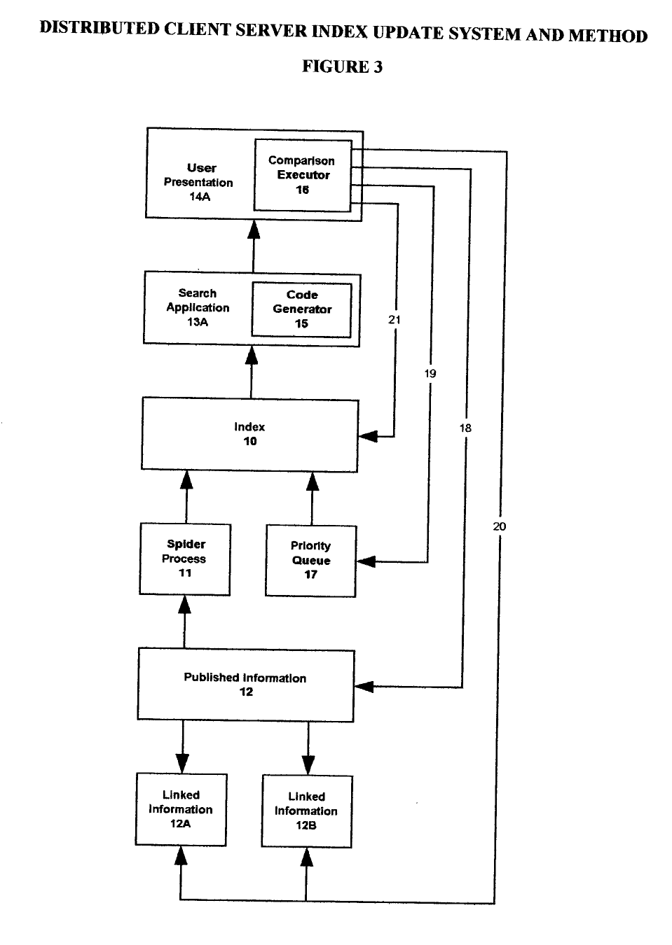

FIG. 3 illustrates the components of a preferred embodiment of the present invention with the addition of recursive index update. Code 16 may enhance index timeliness by recursively traversing 20 pointers or links in found in search result document 12 and comparing said original documents 12A and 12B (whose pointers or links were found in document 12) to their index representation, informing priority queue 17 if said document 12A and/or 12B do not match their index representation, further enhancing the quality of the index 10 by using distributed code 16 execution.

Additionally, specific clients and client source domains (where clients execute) can be identified by priority queue 17 to select an appropriate re-indexing priority. This is used to insure rouge clients or network domains cannot influence the index in a negative way, or that specific network domains may have higher priority in getting their re-indexing requests executed.

### Conclusion

A system and method has been shown in the above embodiments for the effective implementation of a method and system for providing an up-to-date document index using distributed execution. While various preferred embodiments have been shown and described, it will be understood that there is no intent to limit the invention by such disclosure, but rather, it is intended to cover all modifications and alternate constructions falling within the spirit and scope of the invention as defined in the claims. For example, the present invention should not be limited by data sources, data destination platforms, data transmitter platforms, network architecture, platform operating systems, network topology, spider walk method, index architecture, user interface, or search application algorithm.

I claim:

1. A method of maintaining an up to date index comprising the following steps:
generating code for client-side execution;
executing said code on clients;
said code checking index document representation against original document; and
transmitting pointers or links of found documents with out-of-date index entries to a priority queue;

2. A method of providing an up to date index, as per claim 1, comprising the additional step:
in response to multiple index-update requests from said code to priority queue, priority of re-index request increases to insure the more searches are performed on a document, the more up-to-date its index entry shall be.

3. A method of providing an up to date index, as per claim 1, comprising the additional step:
code executing on client performs linear and recursive traversal of links or pointers found in original document or documents, testing each traversed document with its index representation; and
transmitting pointers or links of found documents with out-of-date index entries to a priority queue

4. A method of providing an up to date index, comprising the combination of claim 1 and claim 2.

5. A method of providing an up to date index, comprising the combination of claim 1 and claim 3.

6. A method of providing an up to date index, comprising the combination of claim 1, claim 2 and claim 3.

7. A system for providing an up to date index comprising elements described in claims 1, 2 and 3 including:
a code generator on the server-side of the system;
code execution method on the client-side of the system; and
a priority queue on the server-side of the system.

8. A method of maintaining an up to date index comprising elements described in claims 1 including:
Selecting a re-index priority based on the identity or the origin of the requesting client;
